(19) United States
(12) Patent Application Publication
(10) Pub. No.: US 2026/0087425 A1
(43) Pub. Date: Mar. 26, 2026

(54) ELECTRONIC DEVICE FOR HIGH-PRECISION BEHAVIOR PROFILING FOR TRANSPLANTING WITH HUMANS' INTELLIGENCE INTO ARTIFICIAL INTELLIGENCE AND OPERATING METHOD THEREOF

(71) Applicant: Korea Advanced Institute of Science and Technology, Daejeon (KR)

(72) Inventors: Sang Wan LEE, Daejeon (KR); Dongjae Kim, Daejeon (KR); Jae Hoon Shin, Daejeon (KR)

(73) Assignee: Korea Advanced Institute of Science and Technology, Daejeon (KR)

(21) Appl. No.: 19/408,156

(22) Filed: Dec. 3, 2025

Related U.S. Application Data
(63) Continuation of application No. 17/141,841, filed on Jan. 5, 2021.

(30) Foreign Application Priority Data
Mar. 9, 2020 (KR) 10-2020-0028772
Sep. 29, 2020 (KR) 10-2020-0126999

(51) Int. Cl. G06Q 10/063; G06F 3/01; G06F 17/15; G06F 18/21; G06N 3/004

(52) U.S. Cl. CPC G06Q 10/063; G06F 3/015; G06F 17/15; G06F 18/217; G06N 3/004

(57) ABSTRACT

Provided are an electronic device for precision behavior profiling for transplanting humans' intelligence into AI and an operating method thereof, which may be configured to theoretically design at least one environmental factor, fit a first level model from human's processing data for a task based on the environmental factor, fit a second level model from processing data of the first level model for the task based on the environmental factor, and determine the second level model as a transplant model for humans' intelligence based on a correlation between the first level model and the second level model through profiling for the first level model and the second level model. According to various embodiments, the human's processing data may include at least any one of behavioral data or a brain signal generated while the human processes the task.

### CROSS-REFERENCES TO RELATED APPLICATIONS

This U.S. non-provisional application is a continuation application of U.S. application Ser. No. 17/141,841, filed Jan. 5, 2021, which claims priority under 35 U.S.C. 119 to Korean Patent Application Nos. 10-2020-0028772 filed on Mar. 9, 2020, and 10-2020-0126999 filed on Sep. 29, 2020, in the Korean intellectual property office, the disclosures of which are herein incorporated by reference in their entirety.

### TECHNICAL FIELD

Various embodiments relate to an electronic device for high-precision behavior profiling for transplanting humans' intelligence into artificial intelligence (AI) and an operating method thereof.

### BACKGROUND OF THE INVENTION

In research of the existing human intelligence, model-based analysis that simulates a decision-making process is a major research methodology because the decision-making process accompanied by the research is immanent and hidden. In this methodology, an optimum model for describing the humans' behavior is selected with maximum likelihood, and human intelligence performed within the brain is described based on the model. However, in such a process, a characteristic necessary to perform an actual task and a danger of overfitting that is present independently and immanently cannot be determined based on a criterion for selecting an optimum model. In particular, there are limitations in that human intelligence cannot be transplanted into AI based on a deep neural network having a high danger of overfitting.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Various embodiments provide an electronic device for developing AI for predicting a behavior profile of the human and an operating method thereof.

Various embodiments provide an electronic device for high-precision behavior profiling for transplanting humans' intelligence into AI and an operating method thereof.

According to various embodiments, an operating method of an electronic device may include fitting a first level model based on human's processing data for a task, fitting a second level model based on processing data of the first level model for the task, and determining the second level model as a transplant model for the humans' intelligence through profiling for the first level model and the second level model.

According to various embodiments, a memory and a processor connected to the memory and configured to execute at least one instruction stored in the memory. The processor may be configured to fit a first level model based on human's processing data for a task, fit a second level model based on processing data of the first level model for the task, and determine the second level model as a transplant model for the humans' intelligence through profiling for the first level model and the second level mode.

According to various embodiments, a computer program coupled to a computing device and stored in a recording medium readable by the computing device may execute fitting a first level model based on human's processing data for a task, fitting a second level model based on processing data of the first level model for the task, and determining the second level model as a transplant model for the humans' intelligence through profiling for the first level model and the second level model.

According to various embodiments, AI similar to humans' intelligence can be developed. A transplant model capable of simulating a high-precision behavior profile, that is, a high-level index for humans' intelligence, can be developed. The transplant model can be transplanted into AI without a danger of overfitting. Accordingly, the humans' behavior can be understood and predicted within the humans' behavior category in an overall human-assisted system, such as an AI secretary including the IoT field, because AI ca restore a behavior profile of the human.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram illustrating an electronic device according to various embodiments.

FIG. 2 is a diagram illustrating an operating method of the electronic device according to various embodiments.

FIGS. 3A and 3B are diagrams for describing a reinforcement learning (RL) theory-based environment design operation of FIG. 2.

FIG. 4 is a diagram illustrating a first level model fitting operation of FIG. 2.

FIG. 5 is a diagram for describing the first level model fitting operation of FIG. 2.

FIG. 6 is a diagram illustrating a second level model fitting operation of FIG. 2.

FIG. 7 is a diagram for describing the second level model fitting operation of FIG. 2.

FIGS. 8 and 9 are diagrams for describing a second level profiling operation of FIG. 2.

FIG. 10 is a diagram illustrating a transplant model determination operation in FIG. 2.

FIG. 11 is a diagram for describing the operation of determining a transplant model in FIG. 2.

FIG. 12 is a flowchart illustrating a quantification method for designing a generalizable human mimic type RL model according to various embodiments.

FIG. 13 is a block diagram schematically illustrating a quantification apparatus for designing the generalizable human mimic type RL model according to various embodiments.

FIG. 14 is a diagram for describing human latent policy learning, a reliability test and an empirical generalizability test according to various embodiments.

FIG. 15 is a diagram for describing structures of RL models used in experiments according to various embodiments.

FIG. 16 is a diagram for describing a simulation environment for the generalization test on each RL model according to various embodiments.

FIG. 17 is a diagram illustrating simulation results of the adaptability of the RL model according to various embodiments.

### DETAILED DESCRIPTION

While illustrative embodiments have been illustrated and described, it will be appreciated that various changes can be made therein without departing from the spirit and scope of the invention.

Hereinafter, various embodiments of this document are described with reference to the accompanying drawings.

Various embodiments provide an electronic device for high-precision behavior profiling for transplanting humans' intelligence into artificial intelligence (AI) and an operating method thereof.

According to various embodiments, there is provided a model having the same characteristic as the human's task performance characteristic. (1) To development a model through precision profiling for the human's task performance process: A computational model may be developed by analyzing the human's task performance characteristic, and a model for restoring characteristics necessary to execute an actual task may be developed. (2) To determine overfitting through a high-precision behavior profile comparison: overfitting may be evaluated through a comparison between an actual behavior profile and the behavior profile of the model developed in (1). (3) Human intelligence-AI transplant: Human intelligence may be transplanted into AI without a danger of overfitting through the model capable of simulating the high-precision behavior profile, that is, a high-level index of human intelligence.

According to various embodiments, there are provided human task performance process precision profiling, a technique for developing the human intelligence model based on the human task performance process precision profiling, and a technique for transplanting human intelligence into AI by removing a danger of overfitting. Such the human intelligence-AI transplant technique based on the task performance characteristic precision profiling is a key technique in developing brain recognition-based and brain simulation AI, and is a technique that is new and unresearched compared to the existing technique.

Specifically, (1) To develop the model through the human's task performance characteristic includes extracting, as a behavior profile, a task performance characteristic varying in response to changes in the environment from the human's actual behavior, generating candidate models, and selecting an optimum model by comparing the candidate models. The selected optimum model restores a behavior profile of the human for task performance without change. (2) To determine overfitting through a behavior profile comparison includes extracting a profile of the optimal model again based on a behavior of the optimal model selected in (1) while performing a task and comparing the profile with an actual behavior profile. The two behavior profiles may be compared qualitatively and quantitatively. Through the comparison, the tendency of the two profiles may be qualitatively analyzed. A correlation for a distribution of key parameters that affect a behavior may be quantitatively analyzed. (3) Human intelligence-AI transplant may be performed based on a deep neural network without a danger of overfitting according to the qualitative quantitative decision criterion in (2).

Various embodiments provide (1) precision behavior profiling for a task performance process and the development of the human intelligence model through the precision behavior profiling, and (2) determining whether the human intelligence model is overfit through the behavior profiling. Accordingly, (3) in the transplant of human intelligence-AI, human intelligence can be transplanted into deep neural-based AI without a danger of overfitting.

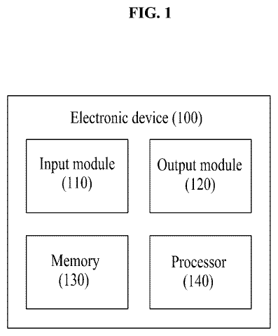

FIG. 1 is a diagram illustrating an electronic device 100 according to various embodiments.

Referring to FIG. 1, the electronic device 100 according to various embodiments may include at least any one of an input module 110, an output module 120, a memory 130 or a processor 140. In an embodiment, at least one of the components of the electronic device 100 may be omitted, and at least another component may be added to the electronic device 100. In an embodiment, at least any two of the components of the electronic device 100 may be implemented as one integrated circuit.

The input module 110 may receive a signal to be used for at least one component of the electronic device 100. The input module 110 may include at least any one of an input device configured to enable a user to directly input a signal to the electronic device 100, a sensor device configured to generate a signal by detecting a surrounding change, or a reception device configured to receive a signal from an external device. For example, the input device may include at least any one of a microphone, a mouse or a keyboard. In an embodiment, the input device may include at least any one of touch circuitry configured to detect a touch or a sensor circuit configured to measure the intensity of a force generated by a touch.

The output module 120 may output information to the outside of the electronic device 100. The output module 120 may include at least any one of a display device configured to visually output information, an audio output device capable of outputting information in the form of an audio signal or a transmission device capable of wirelessly transmitting information. For example, the display device may include at least any one of a display, a hologram device or a projector. For example, the display device may be assembled with at least any one of the touch circuit or sensor circuit of the input module 110, and may be implemented as a touch screen. For example, the audio output device may include at least any one of a speaker or a receiver.

According to one embodiment, the reception device and the transmission device may be implemented as a communication module. The communication module may enable the electronic device 100 to perform communication with an external device. The communication module may establish a communication channel between the electronic device 100 and the external device, and may perform communication with the external device through the communication channel. In this case, the external device may include at least any one of a satellite, a base station, a server or another electronic device. The communication module may include at least any one of a wired communication module or a wireless communication module. The wired communication module is connected to the external device through wires, and may communicate with the external device through the wires. The wireless communication module may include at least any one of a short-distance communication module or a long-distance communication module. The short-distance communication module may communicate with the external device using the short-distance communication method. For example, the short-distance communication method may include at least any one of Bluetooth, WiFi direct, or infrared data association (IrDA). The long-distance communication module may communicate with the external device using the long-distance communication method. In this case, the long-distance communication module may communicate with the external device over a network. For example, the network may include at least any one of a cellular network, the Internet, or a computer network, such as a local area network (LAN) or a wide area network (WAN).

The memory 130 may store various data used by at least one component of the electronic device 100. For example, the memory 130 may include at least any one of a volatile memory or a nonvolatile memory. The data may include input data or output data related to at least one program. The program may be stored in the memory 130 as software including at least one instruction, and may include at least any one of an operating system, middleware, or an application.

The processor 140 may control at least one component of the electronic device 100 by executing a program of the memory 130. Accordingly, the processor 140 may perform data processing or an operation. In this case, the processor 140 may execute an instruction stored in the memory 130.

The processor 140 may design a reinforcement learning (RL) theory-based environment for transplanting humans' intelligence into AI. In this case, the processor 140 may design an environment related to human's task processing. In this case, for example, the processor 140 may determine at least one environmental factor based on a Bellman equation and optimize a corresponding value. For example, the environmental factor may include at least any one of state-transition uncertainty, state-space complexity, a novelty, a state prediction error or a reward prediction error.

The processor 140 may fit a first level model based on the environmental factor. The processor 140 may fit the first level model from human's processing data for a task based on the environmental factor. In this case, the human's processing data for a task may include at least any one of behavioral data or a brain signal generated while the human processes the task. Furthermore, the processor 140 may perform profiling, that is, first level profiling on the human and the first level model. Accordingly, the processor 140 may analyze a correlation between the human and the first level model. For example, when the correlation is a maximum of 1 and the human and the first level model are the same, the correlation may be 1. In this case, the processor 140 may determine the overfitting of the first level model with respect to the human's processing data for the task. To this end, the processor 140 may compare a behavior profile when the human processes the task and a behavior profile of the first level model. The processor 140 may compare a parameter when the human processes the task and a parameter of the first level model.

The processor 140 may fit a second level model. The processor 140 may fit the second level model from the processing data of the first level model for the task based on the environmental factor. Furthermore, the processor 140 may perform secondary profile. Accordingly, the electronic device 100 may analyze a correlation between the first level model and the second level model. In this case, the processor 140 may compare the behavior profile of the first level model and a behavior profile of the second level model. The processor 140 may compare a parameter of the first level model and a parameter of the second level model. Accordingly, the processor 140 may detect the correlation between the first level model and the second level model.

The processor 140 may determine a transplant model for human intelligence. The processor 140 may determine the second level model as the transplant model based on the correlation between the first level model and the second level model. In this case, the correlation between the first level model and the second level model may indicate a degree by which the first level model and the second level model are similar. Accordingly, if the first level model and the second level model are similar by a given level or more, the processor 140 may determine the second level model as the transplant model. For example, when the correlation is a maximum of 1 and the first level model and the second level model are the same, the correlation may be 1.

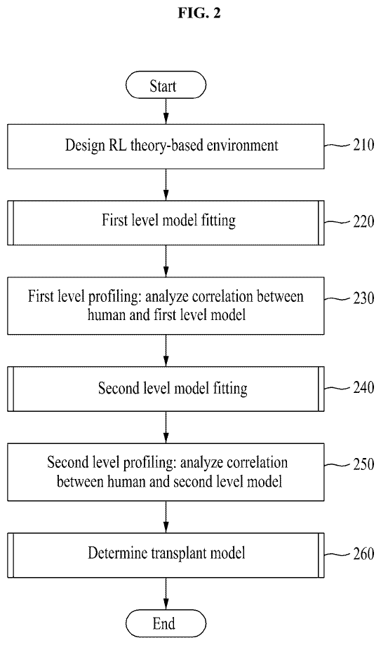

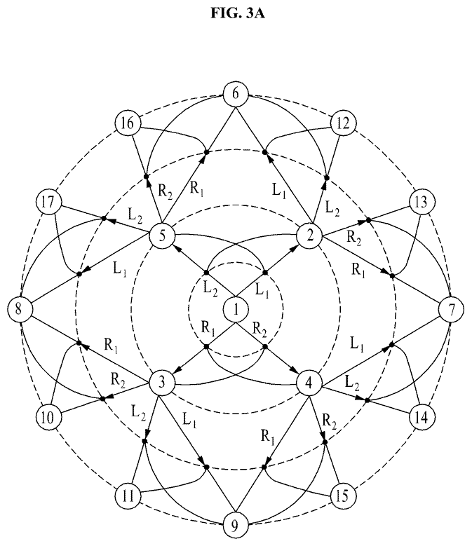

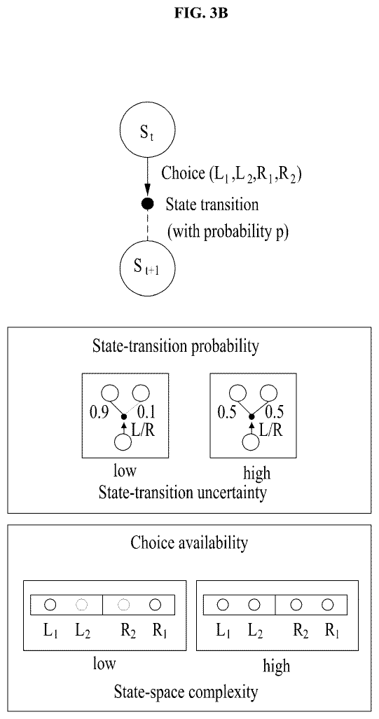

FIG. 2 is a diagram illustrating an operating method of the electronic device 100 according to various embodiments. Furthermore, FIGS. 3A, 3B, 4, 5, 6, 7, 8, 9, 10 and 11 are diagrams for illustratively describing an operating method of the electronic device 100 according to various embodiments.

Referring to FIG. 2, at operation 210, the electronic device 100 may design a reinforcement learning (RL) theory-based environment for implementing humans' intelligence into AI. In this case, the processor 140 may design an environment related to human's task processing. For example, the processor 140 may design a standard task environment for the human based on a reinforcement learning theory which may described at least any one of a task performance process or a problem-solving process when the human processes a task. In this case, for example, the processor 140 may determine at least one environmental factor based on a Bellman equation, and may optimize a corresponding value. For example, the environmental factor may include at least any one of state-transition uncertainty, state-space complexity, a novelty, a state prediction error or a reward prediction error. This will be more specifically described later with reference to FIGS. 3A and 3B.

FIGS. 3A and 3B are diagrams for describing the RL theory-based environment design operation 210 of FIG. 2.

Referring to FIG. 3A, the RL theory-based environment may be represented as at least one state which may occur when the human processes a task, at least one choice performed by the human in each state, and at least one state transition according to each choice. In this case, each node may indicate each state, each arrow may indicate each choise, and each solid line may indicate each state transition. As illustrated in FIG. 3B, a state transition to another state (Sₜ₊₁) may be performed based on a choice in one state (Sₜ). Each state transition may have a state transition probability. For example, state-space complexity may be defined as illustrated FIG. 3B because a plurality of choices is possible for each state. In this case, the higher the number of choices for each state, the higher the state-space complexity is. For example, state-transition uncertainty may be defined as illustrated in FIG. 3B because a plurality of state transitions is possible for each choice. In this case, the greater a difference value between the probabilities of state transitions for each choice, the lower the state-transition uncertainty is.

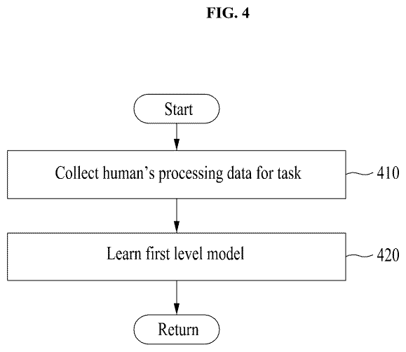

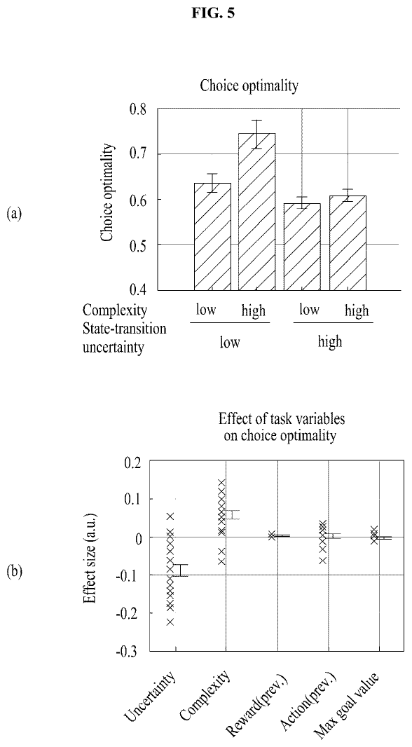

Referring back to FIG. 2, at operation 220, the electronic device 100 may fit the first level model based on the environmental factor. The processor 140 may fit the first level model from human's processing data for the task based on the environmental factor. In this case, the human's processing data for the task may include at least any one of behavioral data or a brain signal generated while the human processes the task. This will be more specifically described later with reference to FIGS. 4 and 5.

FIG. 4 is a diagram illustrating the first level model fitting operation 220 of FIG. 2. FIG. 5 is a diagram for describing the first level model fitting operation 220 of FIG. 2.

Referring to FIG. 4, at operation 410, the electronic device 100 may collect human's processing data for a task. The processor 140 may collect the human's processing data for the task while tracking a process of substantially processing, by the human, the task. In this case, the processor 140 may collect the human's processing data through the input module 110. For example, the processor 140 may collect behavioral data of the human through the input device or the communication module, and may collect a brain signal of the human through the sensor device. For example, the brain signal may include a functional magnetic resonance imaging (FMRI) signal.

At operation 420, the electronic device 100 may learn the first level model based on the human's processing data for the task. The processor 140 may learn the first level model from the human's processing data for the task based on the environmental factor. In this case, at least any one of a behavior profile or at least one parameter of the first level model may be detected. For example, as illustrated in FIG. 5(a), the processor 140 may detect the behavior profile of the first level model. In this case, the behavior profile of the first level model may be detected from at least any one of state-space complexity or state-transition uncertainty. For example, as illustrated in FIG. 5(b), the processor 140 may detect the parameter of the first level model. In this case, the parameter of the first level model may include at least any one of state-transition uncertainty, state-space complexity, a reward according to a state transition from a previous state, an action according to the state transition from the previous state, or a maximum target value. Thereafter, the electronic device 100 may return to FIG. 2 and perform operation 230.

Referring back to FIG. 2, at operation 230, the electronic device 100 may perform profiling, that is, first level profiling for the human and the first level model. Accordingly, the electronic device 100 may analyze a correlation between the human and the first level model. For example, when the correlation is a maximum of 1 and the human and the first level model are the same, the correlation may be 1. In this case, the processor 140 may determine the overfitting of the first level model with respect to the human's processing data for the task. To this end, the processor 140 may compare a behavior profile when the human processes the task and the behavior profile of the first level model. The processor 140 may compare a parameter when the human processes the task and the parameter of the first level model.

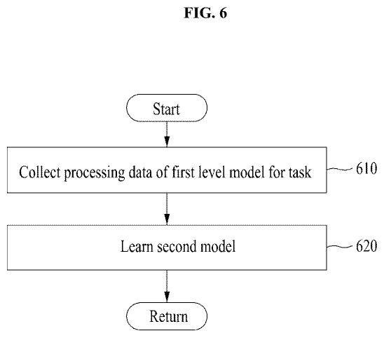

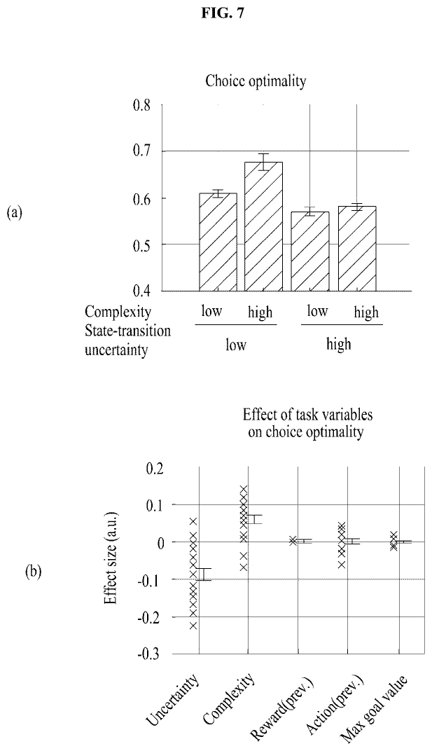

At operation 240, the electronic device 100 may fit the second level model. The processor 140 may fit the second level model from the processing data of the first level model for the task based on the environmental factor. This will be more specifically described later with reference to FIGS. 6 and 7.

FIG. 6 is a diagram illustrating the second level model fitting operation 240 of FIG. 2. Furthermore, FIG. 7 is a diagram for describing the second level model fitting operation 240 of FIG. 2.

Referring to FIG. 6, at operation 610, the electronic device 100 may collect processing data of the first level model for the task. The processor 140 may collect the processing data of the first level model for the task while tracking a process of processing, by the first level model, the task. In this case, at operation 410, the processor 140 processes the task, performed by the human, again using the first level model, and thus may collect the processing data of the first level model for the task.

At operation 620, the electronic device 100 may learn the second level model based on the processing data of the first level model for the task. The processor 140 may learn the second level model from the processing data of the first level model for the task based on the environmental factor. In this case, at least any one of a behavior profile or at least one parameter of the second level model may be detected. For example, as illustrated in FIG. 7(a), the processor 140 may detect the behavior profile of the second level model. In this case, the behavior profile of the second level model may be detected from at least any one of state-space complexity or state-transition uncertainty. For example, as illustrated in FIG. 7(b), the processor 140 may detect the parameter of the second level model. In this case, the parameter of the second level model may include at least any one of state-transition uncertainty, state-space complexity, a reward according to a state transition from a previous state, an action according to the state transition from the previous state or a maximum target value. Thereafter, the electronic device 100 may return to FIG. 2 and perform operation 250.

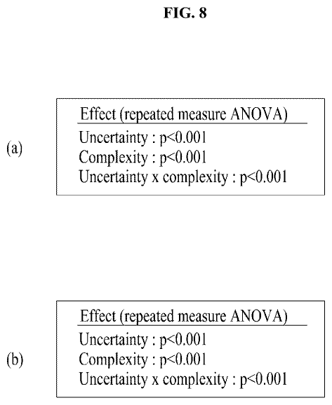

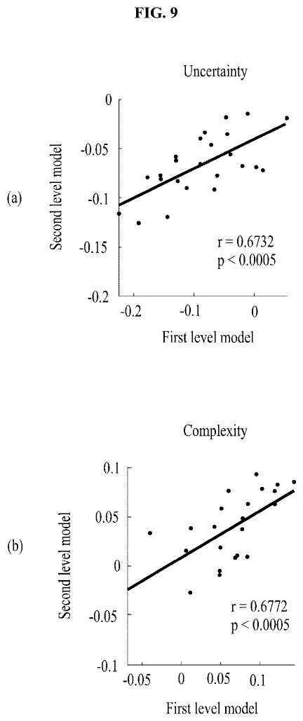

Referring back to FIG. 2, at operation 250, the electronic device 100 may perform second level profiling. Accordingly, the electronic device 100 may analyze a correlation between the first level model and the second level mode. In this case, the processor 140 may compare the behavior profile of the first level model and the behavior profile of the second level model. The processor 140 may compare the parameter of the first level model and the parameter of the second level model. Accordingly, the processor 140 may detect the correlation between the first level model and the second level model. This will be more specifically described later with reference to FIGS. 8 and 9.

FIGS. 8 and 9 are diagrams for describing a second level profiling operation 250 of FIG. 2.

Referring to FIGS. 8 and 9, the processor 140 may detect the correlation between the first level model and the second level model by comparing the first level model and the second level model. To this end, the processor 140 may qualitatively compare a behavior profile of the first level model, such as that illustrated in FIG. 8(a), and a behavior profile of the second level model, such as that illustrated in FIG. 8(b). In this case, the processor 140 may detect the profile correlation by comparing the behavior profile of the first level model and the behavior profile of the second level model. As illustrated in FIGS. 9(a) and 9(b), the processor 140 may quantitatively compare a parameter of the first level model and a parameter of the second level model. In this case, the processor 140 may detect a parameter correlation by comparing the parameter of the first level model and the parameter of the second level model. Furthermore, the processor 140 may detect the correlation between the first level model and the second level model based on at least any one of the profile correlation or the parameter correlation.

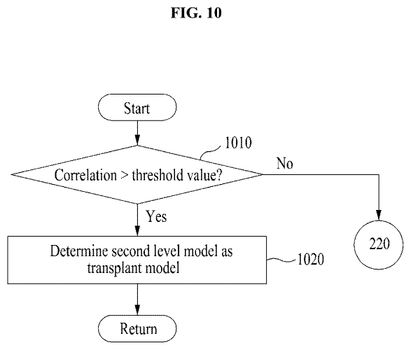

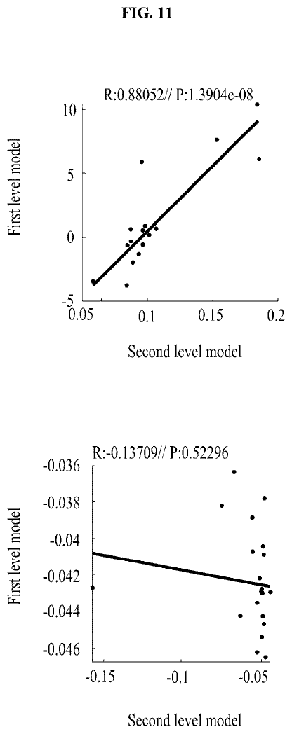

Referring back to FIG. 2, at operation 260, the electronic device 100 may determine a transplant model for human intelligence. The processor 140 may determine the second level model as the transplant model based on the correlation between the first level model and the second level model. In this case, the correlation between the first level model and the second level model may indicate a degree by which the first level model and the second level model are similar. Accordingly, if the first level model and the second level model are similar by a given level or more, the processor 140 may determine the second level model as the transplant model. For example, when the correlation is a maximum of 1 and the first level model and the second level model are the same, the correlation may be 1. This will be more specifically described later with reference to FIGS. 10 and 11.

FIG. 10 is a diagram illustrating the transplant model determination operation 260 of FIG. 2. Furthermore, FIG. 11 is a diagram for describing the transplant model determination operation 260 of FIG. 2.

Referring to FIG. 10, at operation 1010, the electronic device 100 may compare the correlation between the first level model and the second level model with a present threshold value. The processor 140 may determine whether the correlation between the first level model and the second level model is equal to or less than 1 and exceeds the threshold value. For example, when the correlation between the first level model and the second level model is high, the first level model and the second level model may indicate a relation, such as that illustrated in FIG. 11(a). For example, when the correlation between the first level model and the second level model is low, the first level model and the second level model may indicate a relation, such as that illustrated in FIG. 11(b).

At operation 1010, when the correlation between the first level model and the second level model is determined to be equal to or less than the threshold value, the electronic device 100 may return to FIG. 2 and return to operation 220. That is, when the first level model and the second level model is different, that is, the correlation therebetween is less than a given level, the processor 140 may not determine the second level model as the transplant model, and may return to operation 220. Furthermore, the processor 140 may repeatedly perform operation 220 to operation 260.

At operation 1010, when the correlation between the first level model and the second level model is determined to be greater than the threshold value, the electronic device 100 may determine the second level model as the transplant model at operation 1020. That is, when the first level model and the second level model are similar, that is, the correlation therebetween is equal to or greater than a given level, the processor 140 may determine the second level model as the transplant model. Accordingly, the transplant model may be transplanted as AI for humans' intelligence. In this case, since the transplant model is transplanted into an electronic device, for example, a robot, AI according to the transplant model can perform a task or solve a problem like the human.

According to various embodiments, AI similar to humans' intelligence may be developed. A transplant model capable of simulating a high-precision behavior profile, that is, a high-level index for humans' intelligence, can be developed, and the transplant model can be transplanted as AI without a danger of overfitting. Accordingly, since AI can restore a behavior profile of the human, the humans' behavior can be understood and predicted within the humans' behavior category in an overall human-assisted system, such as an AI secretary including the IoT field.

Various embodiments may be adapted and applied to various fields to be described hereunder.

1. Human-robot/computer interaction field: a behavior accompanied by the task performance/problem-solving of the human occurs based on a high dimensional cognition process, and may be applied to in all fields which may be used by predicting the humans' behavior. For example, an affective computing field has an object of reading an emotion, that is, one of types of cognitive statuses of the human and assisting the humans' behavior according to circumstances. The present system may assist the human to achieve excellent performance by constructing an efficiently corresponding system in assisting the human behavior through the prediction of another cognitive status (e.g., vigilance and non-vigilance) contextually similar to an emotion which may be recognized by a computer in addition to simply reading an emotion. Furthermore, this technology may be used as based technology for all applications including the human-robot/computer interaction. Since a suboptimal decision-making process of the human is simulated, a more natural interaction with the human is made possible compared to optimal AI.

2. Smart IoT field: in particular, in the Internet-of-things (IoT) field, a cognition function used to control each device may be various because various devices need to be controlled. In this case, the versatility of the present system can assist the human regardless of a difference in the type of a cognitive status necessary to control each device and can develop AI capable of predicting a behavior without overfitting even when a new device in an already constructed IoT ecosystem.

3. Expert profiling and smart education field: A key high-level cognitive process is directly related to task performance intelligence of the human. Accordingly, this technology enables task performance ability profiling for a judge, a doctor, a financial expert, a military commander, etc. whose complicated decision-making is important. Furthermore, pre-profiling for a customized system for smart education is possible. Furthermore, a task performance capability can be improved by monitoring the task performance capability.

4. AI-human coevolution application field: the understanding of human intelligence is also applied to the understanding of a decision-making process for maximizing a reward in the human's neural level. In the existing AI, the understanding of such the human's decision-making process is not present. However, in the robotics field, AI that better predicts the humans' behavior can be developed through the development of AI that predicts the humans' behavior characteristic without any change. In the gaming field, a more intelligent AI engine can be developed.

5. User-targeted AD field: today an advertising automatic-recommendation technology recommends new advertising based on the past search logs of the human. However, such an advertising suggestion technology chiefly proposes advertising completely out of an interested range of a user because the technology lacks the understanding of an individual humans' behavior characteristic. If this technology is used, advertising efficiency can be maximized because advertising having a direct influence on a behavior/cognition of a user can be recommended.

An operating method of the electronic device 100 according to various embodiments may include fitting a first level model based on human's processing data for a task, fitting a second level model based on processing data of the first level model for the task, and determining the second level model as a transplant model for the humans' intelligence through profiling for the first level model and the second level model.

According to various embodiments, the human's processing data may include at least one of behavioral data or a brain signal generated while the human processes the task.

According to various embodiments, the determining of the transplant model may include detecting a correlation between the first level model and the second level model and determining whether to determine the second level model as the transplant model based on the correlation.

According to various embodiments, the operating method of the electronic device 100 may further include theoretically designing at least one environmental factor.

According to various embodiments, the fitting of the first level model may include fitting the first level model from the human's processing data based on the environmental factor.

According to various embodiments, the fitting of the second level model may include fitting the second level model from the processing data of the first level model based on the environmental factor.

According to various embodiments, the fitting of the first level model may include an operation of learning the first level model based on the human's processing data, thereby at least any one of a behavior profile or at least one parameter of the first level model may be detected based on the environmental factor by the fitting.

According to various embodiments, the fitting the second level model may include an operation of learning the second level model based on the processing data of the first level model, thereby at least any one of a behavior profile or at least one parameter of the second level model may be detected based on the environmental factor by the fitting.

According to various embodiments, the detecting of the correlation may include at least one of an operation of detecting a profile correlation by comparing a behavior profile of the first level model and a behavior profile of the second level model or an operation of detecting a parameter correlation by comparing the parameter of the first level model and the parameter of the second level model, and an operation of detecting the correlation based on at least any one of the profile correlation or the parameter correlation.

According to various embodiments, the determining whether to determine the second level model as the transplant model may include an operation of determining the second level model as the transplant model when the correlation is greater than a present threshold value.

According to various embodiments, the environmental factor may include at least any one of state-transition uncertainty, state-space complexity, a novelty, a state prediction error or a reward prediction error.

An electronic device according to various embodiments may include a memory 130 and a processor 140 connected to the memory 130 and configured to execute at least one instruction stored in the memory 130.

According to various embodiments, the processor 140 may be configured to fit a first level model based on human's processing data for a task, fit a second level model based on processing data of the first level model for the task, and determine the second level model as a transplant model for the humans' intelligence through profiling for the first level model and the second level mode.

According to various embodiments, the human's processing data may include at least one of behavioral data or a brain signal generated while the human processes the task.

According to various embodiments, the processor 140 may be configured to detect a correlation between the first level model and the second level model and to determine whether to determine the second level model as the transplant model based on the correlation.

According to various embodiments, the processor 140 may be configured to theoretically design at least one environmental factor, fit the first level model from the human's processing data based on the environmental factor, and fit the second level model may include fitting the second level model from the processing data of the first level model based on the environmental factor.

According to various embodiments, the processor 140 may be configured to learn the first level model based on the human's processing data, thereby at least any one of a behavior profile or at least one parameter of the first level model may be detected based on the environmental factor by the fitting.

According to various embodiments, the processor 140 may be configured to learn the second level model based on the processing data of the first level model, thereby at least any one of a behavior profile or at least one parameter of the second level model may be detected based on the environmental factor by the fitting.

According to various embodiments, the processor 140 may be configured to detect a profile correlation by comparing a behavior profile of the first level model and a behavior profile of the second level model, detect a parameter correlation by comparing the parameter of the first level model and the parameter of the second level model, and detect the correlation based on at least any one of the profile correlation or the parameter correlation.

According to various embodiments, the processor 140 may be configured to determine the second level model as the transplant model when the correlation is greater than a present threshold value.

According to various embodiments, the environmental factor may include at least any one of state-transition uncertainty, state-space complexity, a novelty, a state prediction error or a reward prediction error.

Rapid advances in reinforcement learning (RL) have offered a great potential for developing algorithms to solve various types of complex problems. For example, hierarchical architectures have been shown to promote efficient exploration with sparse rewards. Model-based RL has demonstrated its ability to improve sample efficiency in many situations. RL algorithms have also established biological relevance, increasing optimism about the building of models with human-like intelligence. Despite their capacity to solve a variety of tasks, there remain several key challenges, such as improving sample efficiency, adaptability, and generalization. For example, RL algorithms lack the ability to rapidly learn the structure of the environment, and behavioral policies thereof are often highly biased, making it hard to adapt to changing environments or transfer their task knowledge to general situations.

Earlier studies showed that value-based decision-making is guided by a reward prediction error (RPE) and the midbrain dopamine neurons encode this information. A later study found that the human brain appears to implement an actor-critic scheme. These studies support the idea that the way the brain learns from experience bears a resemblance to model-free RL. Single model-free RL can account for relatively small variability in behavior and neural data. This conventional view was then challenged by the idea that the brain implements more than one type of RL. Indeed, the human brain is capable of not only combining model-free and model-based RL, but also adaptively choosing one strategy over the other depending on context changes. This adaptive process was found to be guided by a part of the lateral prefrontal cortex, which compiles the reliability of respective predictions made by the model-free and model-based RL strategies. The brain also has a propensity for pursuing a computationally less expensive strategy, such as model-free RL, especially in a highly stable or volatile environment. In contrast, the prefrontal cortex engages in drastically improving sample efficiency of model-based learning by compromising performance reliability. This implies that the brain has an innate ability to deal with the tradeoff between performance, sample efficiency, and computational costs. Critically, it leads to a theoretical implication that the brain explores learning strategies in a way that best responds to new challenges in the environment.

There are a few commonalities between the brain and algorithmic solutions to adaptive RL, but a substantial difference still lies in the way they approach problems. Moreover, the capacity of the brain to effectively deal with the challenges of RL has not been fully developed by RL algorithms. This raises the following interesting questions: Is it possible for the RL models to glean information about human RL directly from human behavioral data? Then, do these imitation models have a similar policy as humans? While many works have successfully demonstrated the effectiveness of policy learning from imitation, little is known about whether their policies are similar to humans' latent policy or whether a policy can be generalized to other tasks. Another potential issue is overfitting. Notably, recent studies examining the recoverability of human behavior have shown that models often fail to replicate the findings based on human behavior data, to which they are originally fitted. This suggests that the learned behavioral policy of computational models does not fully reflect the innate dynamics of human RL.

A current RL algorithm shows a capability exceeding human intelligence with respect to some problems, but the humans' RL is excellent in the following aspects.

The humans' RL enables minimal supervision learning relatively well performed although the amount of data is not sufficient, and has high efficiency learning having low energy consumption and high performance in accordance with biological cognitive resource limitations. Due to such a learning capability, the humans' RL eventually enables generalization as a multi-task.

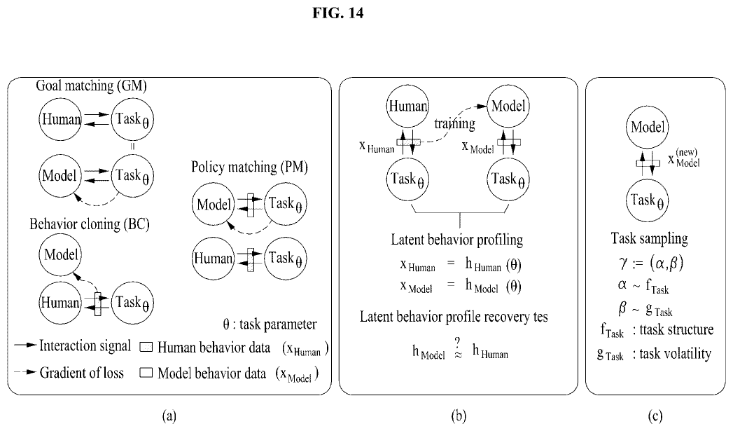

The following various embodiments provide a multilateral quantification process essential for the design of the human mimic type RL algorithm having an autonomous, high efficiency, and generalizability.
Process 1. A policy reliability quantification process: context-dependent RL behavioral data of the human is likely to be overfitted in an inverse RL process due to a very complicated time-space correlation. In order to prevent this problem, policy reliability of the RL algorithm is quantified as follows. After a mapping function between a task parameter and a behavior profile of the human is approximated and a mapping function between the task parameter and a behavior profile of the RL algorithm is approximated, a quantification process (FIG. 14(b)) of comparing the two mapping functions is performed.
Process 2. A generalizability validation process: for precise validation of the generalizability, that is, the final aim of the humans' RL process simulation algorithm, there is provided a process (FIG. 14(c)) of validating performance for a series of tasks (task generalization probability) sampled in a continuous task space in which the complexity of an actual problem and context changes are parameterized.
Process 3. A problem-solving information processing efficiency quantification process: this provides a quantification (episodic encoding efficiency) process in a Markov chain viewpoint in order to identify an “organic connectivity” with the adaptability of the humans' RL simulation algorithm (quantification into the aforementioned policy reliability quantification process (process 1)) that changes a problem-solving policy depending on context changes and a generalizability for various types of problem-solving (the aforementioned generalizability validation process (process 2)). A goodness-of-fit statistics of information compression efficiency in which the past episode occurring in the problem-solving process is incorporated into an RL policy and a behavior derived from the RL policy is calculated using mutual information in a Markov chain connected by an episode-policy-behavior. This ratio is an index indicative of an information transfer system that incorporates episode information in determining the RL policy in order to execute an optimal problem-solving/task.

All of the three processes are new techniques not present in the existing technology. The present disclosure provides the first instance to actually demonstrate that a “generalizable humans' RL capability” can be algorithmized without overfitting.

Through such a series of processes showed that a generalizable humans' RL simulation algorithm having high reliability and not having overfitting can be designed and that this cannot be implemented by only the existing simple inverse RL process.

In a policy reliability aspect, that is, an index of Process 1, the index can be improved 5 times or more compared to a recent RL algorithm. Generalizability, that is, an index of Process 2, can be improved by 12.8%. An optimal behavior effect can be improved about by 100% compared to episodic encoding efficiency, that is, an index of Process 3. This is more specifically described below through empirical study results using the proposed technology.

The RL algorithm solves a problem through value-based learning similar to the biological dopamine system. In recent studies, a deep learning-based RL algorithm (e.g., AlphaGo and Alpha Zero) emerges and shows performance exceeding humans' intelligence with respect to a complicated problem, such as Baduk. However, such a high-performance RL algorithm has clear limitations in its performance because it misses all characteristics of human intelligence.

A common AI RL algorithm requires many data in learning, and is aimed at improving performance rather than efficiency, and cannot be generalized into various problems because it has been specialized for solving a specific problem situation. In contrast, the humans' RL process requires a small amount of data, has an excellent minimal supervision learning characteristic capable of learning, has a high efficiency characteristic that enables learning while reducing energy consumption due to limited biological cognitive resources, and has a characteristic having common intelligence for various situations without being limited to a specific problem situation.

In order to transplant only such advantages of the humans' RL process into an AI RL algorithm, the following approaches are necessary. (1) A human RL simulation RL algorithm is optimized. (2) A human intelligent characteristic of the RL algorithm is confirmed (behavior level): Whether a behavior simulated through the corresponding RL algorithm has a form similar to a behavior of human intelligence may be directly compared through various behavior profiles. (3) A human intelligence characteristic of the RL algorithm is identified (parameter level): Whether a simulation behavior extracted through each RL algorithm has been trained again as each RL algorithm and maintains a characteristic of human intelligence may be validated based on a change in the parameter level. (4) A characteristic of human intelligence is validated in the information theory level: A characteristic of natural intelligence may be analyzed through a comparison between pieces of mutual information between the behavior and the environment. In particular, how high reliability does a specific RL algorithm have with respect to a characteristic of each natural intelligence may be analyzed can be analyzed based on a distribution of the mutual information.

The present disclosure proposed as described above handles a technique for developing and validating the RL algorithm in order to foster advantages of human intelligence which are insufficient in the AI RL algorithm. The validation method based on a comparison between such development and another RL algorithm is an independent technology unresearched in the existing technology.

The present disclosure includes a quantification process essential to transplant the generalizability of the humans' RL process into an RL algorithm. A generalizable RL algorithm having high reliability can be designed by (1) quantifying how a model derived through inverse RL incorporates context changes in the task into a policy, (2) quantifying the generalizability of tasks sampled from a parameterized task space, and finally (3) quantifying whether a changed and movement process of information connected from an environment to a behavior in the information theory viewpoint properly incorporates the behavior principle of key human intelligence.

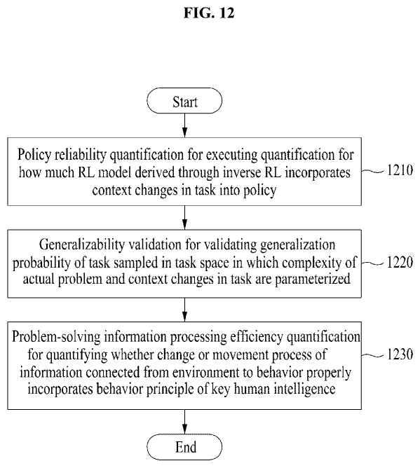

FIG. 12 is a flowchart illustrating a quantification method for designing a generalizable human mimic type RL model according to various embodiments.

Referring to FIG. 12, the quantification method for designing a generalizable human mimic type RL model executed through a computer according to various embodiments may include a policy reliability quantification step 1210 of executing quantification for how much an RL model derived through inverse RL incorporates context changes in the task into a policy in order to transplant, into the RL model, the generalizability of the humans' RL process.

Furthermore, for precise validation of the generalizability, the quantification method may further include a generalizability validation step 1220 of validating the generalization probability of a task sampled in a task space in which the complexity of an actual problem in the task and context changes are parameterized.

Furthermore, the quantification method may further include a problem-solving information processing efficiency quantification step 1230 of quantifying whether a change or movement process of information connected from an environment to a behavior properly incorporates the behavior principle of key human intelligence.

The steps of the quantification method for designing a generalizable human mimic type RL model executed through a computer according to various embodiments are more specifically described below.

The quantification method for designing a generalizable human mimic type RL model according to various embodiments may be described by taking a quantification apparatus for the generalizable human mimic type RL model design as an example.

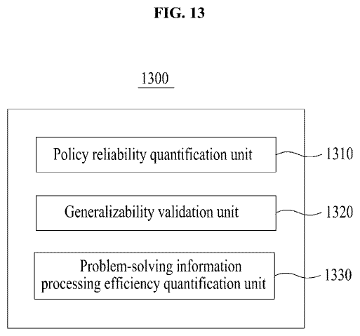

FIG. 13 is a block diagram schematically illustrating a quantification apparatus 1300 for designing the generalizable human mimic type RL model according to various embodiments.

Referring to FIG. 13, the quantification apparatus 1300 for designing the generalizable human mimic type RL model according to various embodiments may include a policy reliability quantification unit 1310, and may further include a generalizability validation unit 1320 and a problem-solving information processing efficiency quantification unit 1330 depending on an embodiment.

In the policy reliability quantification step 1210, the policy reliability quantification unit 1310 may execute quantification for how much an RL model derived through inverse RL incorporates context changes in the task into a policy in order to transplant, into the RL model, the generalizability of the humans' RL process.

In a task, that is, all situations where the human experiences learning, humans' RL correspond to changes in the policy as if a specific behavior pattern appears depending on a change in various types of context (e.g., the uncertainty of an environment, complexity, and a reward condition). For example, when context changes in which the uncertainty of an environment increases occur, a policy that sublates effectiveness is selected because the human does not have the effectiveness for a target-oriented behavior. It is also necessary to validate whether the RL model that simulates the human through inverse RL shows the same policy. Various methods may be proposed as a method for quantifying a behavior pattern change (i.e., a change in the policy) according to context changes, but representatively, an influence that a specific context change contributes to a policy change through regression analysis may be quantified based on a regression coefficient.

More specifically, the policy reliability quantification step 1210 may include the step of approximating a mapping function between a task parameter of a task and a behavior profile of the human, approximating a mapping function between the task parameter and a behavior profile of an RL algorithm, and comparing the approximated two mapping functions.

In this case, an RL model may be a computational model in which model-based control for reliably encoding policy information learnt by the human and model-free control are combined. Furthermore, the RL model may be constructed through a learning method of goal matching (GM), behavior cloning (BC) and policy matching (PM), which are more specifically described.

In the generalizability validation step 1220, the generalizability validation unit 1320 may validate the generalization probability of a task sampled in a task space in which the complexity of an actual problem in the task and context changes are parameterized for precise validation of the generalizability.

The generalizability is a learning characteristic of the human, and makes a policy change characteristic according to context changes appearing in one task identically appear in another task. It could be seen that the model (i.e., validated in step 1210) into which the humans' RL characteristic shown to learn a specific task and maximize a reward, that is, a policy change according to context changes, has been successfully incorporated shows generalizable performance through a characteristic of the human even in a task whose another context, such as the complexity of a problem changes. In order to widely validate this, a multi-task may be produced by parameterizing the complexity of a problem and context changes and adjusting them, and generalizability may be validated through performance by exposing the multi-task.

In the problem-solving information processing efficiency quantification step 1230, the problem-solving information processing efficiency quantification unit 1330 may quantify whether a change or movement process of information connected from an environment to a behavior properly incorporates the behavior principle of key human intelligence.

The behavior principle of human intelligence lies in an efficient distribution of resources. Lots of cognitive efforts are necessary depending on a change in context, but human intelligence may show a target-oriented behavior having high performance and may show a habitual behavior having enhanced efficiency. In general, the human has a behavior pattern having high performance and high efficiency through a proper distribution of the two policies. In order to quantify whether the policy is properly changed, two types of mutual information may be used. The first is mutual information between a previous experience and a current choice. If this value is low, this may be understood as an efficient choice through the compression of information (efficiency index). The second is mutual information between a current choice and a choice having the best reward value (optimal choice) among current choices. If this value is high, this may be considered to be high performance (performance index). Efficiency of information processing relating to whether the behavior principle of human intelligence is restored can be quantified based on the two ratios of mutual information (performance index/efficiency index).

The problem-solving information processing efficiency quantification unit 1330 may perform quantification using the Markov chain in order to check connectivity between the adaptability of the human mimic type RL model that changes a problem-solving policy depending on context changes through the policy reliability quantification unit 1310 and generalizability validated for problem-solving through the generalizability validation unit 1320.

Furthermore, the problem-solving information processing efficiency quantification unit 1330 may calculate information compression efficiency in which the past episode generated in a problem-solving process is incorporated into an RL policy and goodness-of-fit statistics of a behavior derived from the RL policy based on mutual information on the Markov chain connected as an episode-policy-behavior.

In this case, the goodness-of-fit statistics of the behavior may be an index indicative of an information transfer system that incorporates episode information in determining the RL policy for optimal problem-solving.

A quantification method and apparatus for designing a generalizable human mimic type RL model according to various embodiments will be more specifically described below.

Although deep RL models have shown a great potential for solving various types of tasks with minimal supervision, several key challenges remain in terms of learning rapidly from limited experience, adapting to environmental changes, and generalizing learning from a single task. Recent evidence in decision neuroscience has shown that the human brain has an innate capacity to resolve these issues, leading to optimism regarding the development of neuroscience-inspired solutions toward sample-efficient, adaptive, and generalizable RL algorithms.

It was shown that a computational model in which model-based and model-free control, called a prefrontal RL, are adaptively combined reliably encodes information of a high-level policy that humans learned. This model may generalize the learned policy to a wide range of tasks.

First, the prefrontal RL, deep RL, and meta RL algorithms were trained by 82 human subjects' data, collected while human participants were performing two-stage Markov decision tasks. In this process, the goal, state-transition uncertainty, and state-space complexity were experimentally manipulated. In the reliability test based on a combination of the latent behavior profile and the parameter recoverability test, it was found that the prefrontal RL reliably learned the latent policies of the human subjects, whereas all the other models failed to pass this test. Second, to empirically test the ability to generalize what these models learned from the original task, the models were situated in the context of environmental volatility. Specifically, large-scale simulations were performed with 10 different Markov decision tasks. In this task, latent context variables changed over time. Information-theoretic analysis according to various embodiments shows that the prefrontal RL shows the highest level of adaptability and episodic encoding efficacy. This is the first attempt to formally test the possibility that computational models mimicking the way the brain solves general problems can lead to practical solutions to key challenges in machine learning.

In the present disclosure, the following fundamental question is reviewed. Whether an algorithm can learn a generalizable policy for the human? To this end, in this problem, a pre-condition for the reliability test and the empirical generalizability test is taken as two official tests. The test of the present disclosure is summarized as follows.

Learning human latent policy. In this case, 82 human subjects' data is fit to different types of RL models, each of the RL modes implements model-free control and model-based control in different ways, including deep RL, meta RL, and prefrontal RL. Data collected from human participants performing two-stage Markov decision tasks, in which the goal, state-transition uncertainty, and state-space complexity were experimentally manipulated, was used.

Reliability test. The latent policy of the computational model in which model-based control and model-free control called prefrontal RL are adaptively combined using rigorous latent behavior profile recoverability tests is qualitatively similar to that of human subjects, whereas all other models fail to replicate the effect.

Empirically generalizability test. In order to test the model's ability to generalize what it learned from the original task, large-scale simulations with 10 different in which a context parameter is changed over time were performed. In this case, the prefrontal RL showed the highest level of adaptability and episodic encoding efficacy.

This task is the first attempt for officially testing the probability that the computational model can reliably learn the latent policy of the human. Furthermore, this approach enables more human-like intelligence to be designed by providing a substantial solution to major challenges of machine learning.

### Human Latent Policy Learning

FIG. 14 is a diagram for describing the human latent policy learning, the reliability test, and the empirical generalizability test according to various embodiments.

Referring to FIG. 14(a), in order to build RL models that learn and perform tasks in a similar way as humans, the three training methods, including goal matching (GM), behavior cloning (BC), and policy matching (PM), are considered. In this case, a process called human latent policy learning is intended to learn a behavioral policy directly from human behavioral data.

The RL model interacts with a task environment to maximize a expected amount of a future reward, so it does not use any human behavior data for training. However, a task (goal) used for training the model is exactly the same as one performed by human subjects. For this reason, this method is called goal matching (GM).

Policy matching (PM) combines goal matching (GM) and behavioral cloning (BC), making it possible to achieve both goal matching and behavior matching. Specifically, the RL model is trained in such a way that it mimics the way that the human performs reward maximization. In each training epoch, the RL model completes one episode of a task to maximize reward (goal matching). Thereafter, a difference between a behavior of the model and that of the human subject is translated into a loss function (behavior cloning). This method was previously used for training computational models to account for neural data. It should be noted that a standard inverse RL method was not considered because the RL method cannot be directly applicable to tasks with rapid context changes. Indeed, it is almost impossible for the inverse RL method to estimate our reward function, in which both a reward value and environmental statistics change over time, and a sample size is too small (around 400 trials per subject).

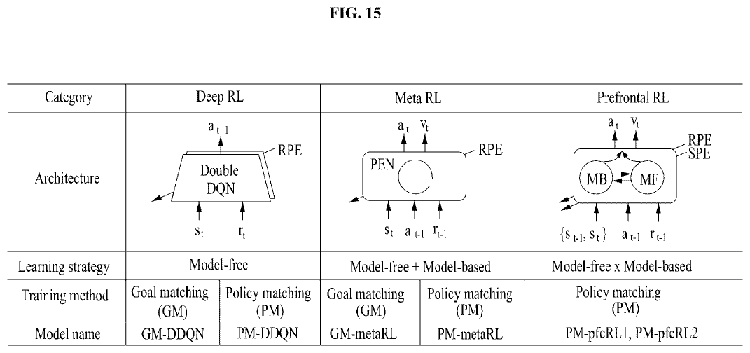

FIG. 15 is a diagram for describing structures of RL models used in experiments according to various embodiments.

Referring to FIG. 15, for experiments, three RL models of deep RL, meta RL, and prefrontal RL were used. The first type was implemented as double DQN (deep RL) also known as DDQN. This is one of representative deep RL models closed to model-free RL. In order to train the models (GM-DDQN and PM-DDQN), both the goal matching and policy matching methods were used.

The second type was implemented as the meta RL. This model accommodates both model-free RL and model-based RL. In particular, the meta RL is known to adaptively respond to contextual changes in the environments. Both the goal matching and policy matching methods were used to train the models (GM-meta RL and PM-metaRL, respectively).

The third type of the RL models was implemented with a computational model to account for the neural activity of the lateral prefrontal cortex and ventral striatum (prefrontal RL). This model includes two versions: a baseline model and an adaptive model. These models learn a task by dynamically arbitrating between model-free RL and model-based RL. Specifically, the models adjust, on a trial-by-trial basis, a degree of control allocated to model-free and model-based RL strategies. A top-down control signal is computed based on the prediction reliability of each RL strategy. The policy matching method was used to train the two models (PM-pfcRL1 and PM-pfcRL2, respectively). In this case, the goal matching was not used because previous studies found that this method is not effective in fitting these models to data.

### Reliability of Brain-Inspired RL Models

As illustrated in FIG. 14(b), in order to assess to what extent the RL models reliably learn to mimic the human behavior and latent policy, a reliability test was performed. The test validates the capacity to encode information of a high-level policy that the humans learned while performing a task. The process consists of latent behavior profiling and a recovery test.

One general way to assess a latent policy that humans learn from a task is to quantify the effect of latent task parameters (e.g., goal and state-transition uncertainty) on behavior. This measure reflects how the learning agent changes its behavior in response to the change in an environment structure. For a given task parameter θ and behavioral data x, a latent behavior profile h is defined as in the following equation:

$$x = h ( {θ}_{Task} ) \qquad ( 1 )$$

wherein h may be any parameterized function, such as a polynomial function or a neural network. If task performance of an agent is independent of context changes or if the agent makes random choices, an effect size (i.e., parameter values of h) would be zero. In this case, a general linear model is simply used as h.

A purpose of the latent behavior profile recovery test is to evaluate consistency between a latent policy of the human and that of the RL model. After the model's parameters is fit to data x_{Human} of the human subject, simulated data x_{Model} is generated by performing simulations using the original fitting model on the original task. Thereafter, latent behavior profiling is performed on each of x_{Human} and x_{Model}. A significant positive correlation between these two latent profiles indicates that the latent policy that the RL model learned is similar to the latent policy of the human.

For the reliability test, in order to examine the recoverability of the latent behavior profile, a series of experiments were performed based on six different RL models (FIG. 15) and a random agent as a control condition. In the first step, prefrontal RL, meta RL, and deep RL were trained on 82 human subjects' data (x_{Human} in FIG. 14(b)). A dataset was collected while the human subjects performed two-stage Markov decision tasks. In the second step, another behavioral dataset (x_{Model} in FIG. 14(b)) by performing another set of simulations in which all the RL models performed the same two-stage Markov decision task. Thereafter, latent behavior profiles h_{Human} and h_{Model} are computed as in the following equation.

$${x}_{Human} = {h}_{Human} ( {θ}_{Task} ) , {x}_{Model} = {h}_{Model} ( {θ}_{Task} ) \qquad ( 2 )$$

wherein θ_{Task} indicate task parameters. This is a large-scale experiment, including more than 1,000 model fitting processes.

7(models)×82(subjects)×2(training and retraining).

In the results of the reliability test according to various embodiments, in terms of model fitting that quantifies behavior matching between RL models and human subjects, the PM-meta RL showed the highest performance, followed by the prefrontal RL and the deep RL. As expected, the RL models trained with goal matching showed relatively poor fitting performance.

However, in the systematic recovery analysis of the latent behavior profiles, it was found that the latent behavior profile of the prefrontal RL model (PM-pfcRL2) was qualitatively similar to that of the human subjects. In contrast, all of other RL models did not clone the effect. Although the meta RL trained with the PM method showed a significant correlation, the correlation is negative, indicating that the way this model performs the task may be fundamentally different from that of humans. When computing goodness-of-fit statistics by taking into account both the steepness and the significance of the correlation, this effect becomes more dramatic. An effect size of the prefrontal RL model (PM-pfcRL2) is more than three times larger than effect sizes of all the other RL models. These results suggest that simply imitating human behavior does not necessarily mean that the agent actually learns the latent policy of the human.

### Empirical Generalizability of Brain-Inspired RL Models

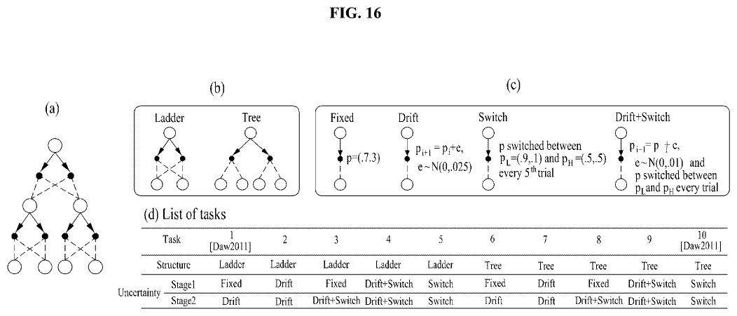

FIG. 16 is a diagram for describing a simulation environment for the generalization test on each RL model according to various embodiments.

Referring to FIG. 16, in order to empirically test the models' capacity to generalize from what they learned from the original task to other tasks (FIG. 14(c)), the models are situated in the context of environmental volatility. Large-scale simulations with 10 different Markov decision tasks, each of which manipulated latent context variables in different ways, were performed using the same RL models as those described above. The tasks were created by systematically manipulating two task parameters, including a task structure (ladder and tree) and task uncertainty (fixed, drift, switch, and drift+switch). As illustrated in FIG. 16(b), a ladder and tree type were used for the task structure. As illustrated in FIG. 16(c), for a task uncertainty change, four different types of state transition functions were reviewed. A state-transition probability value of each of state transition functions was changed in a different manner on a trial-by-trial basis.

The first type (“fixed”) uses a fixed state-transition probability. The second type (“drift”) uses a state-transition probability following random walks in which a state-transition probability value changes relatively slowly. The third type (“switch”) alternates between two different state-transition conditions having low and high uncertainties, respectively. In this task, a learning agent experiences abrupt changes in the task structure and needs to adapt quickly. The fourth type (“drift+switch”) is a mixture of the second and third types. Full configurations of each task are provided in FIG. 16(d). Task 1 and Task 10 correspond to tasks used in previous studies investigating the brain's RL processes.

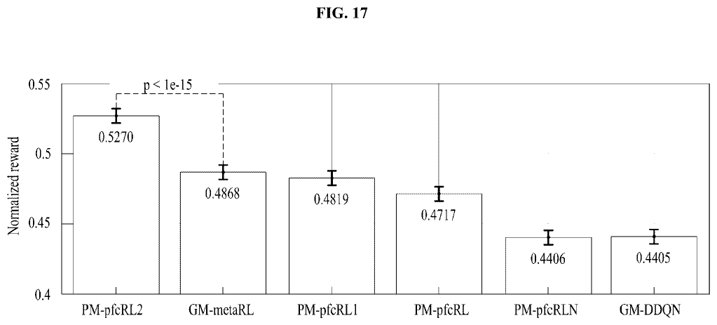

FIG. 17 is a diagram illustrating simulation results of the adaptability of the RL models according to various embodiments.

In order to test empirical generalizability, simulations in which the six RL models (the aforementioned RL models) trained on the original dataset performed 10 Markov decision tasks were performed. The simulations included a total of 4,920 simulations (=82 subjects×6 RL models×10 tasks). Average performance across all the tasks represents the empirical generalizability, and performance on each task represents the adaptation ability of a corresponding model in different situations. Referring to FIG. 17, it can be seen that the prefrontal RL model has the highest level of generalizability.

TABLE 1

| | Task 1 | Task 2 | Task 3 | Task 4 | Task 5 | Task 6 | Task 7 | Task 8 | Task 9 | Task 10 | Success rate |
|---|---|---|---|---|---|---|---|---|---|---|---|
| PM-DDQN | FAIL | FAIL | FAIL | FAIL | FAIL | FAIL | FAIL | FAIL | FAIL | FAIL | 0/10 |
| GM-DDQN | FAIL | FAIL | FAIL | FAIL | FAIL | FAIL | FAIL | FAIL | FAIL | FAIL | 0/10 |
| PM-metaRL | FAIL | FAIL | 0.35 | FAIL | FAIL | 0.36 | 0.59 | 0.59 | FAIL | FAIL | 4/10 |
| GM-metaRL | FAIL | FAIL | 0.38 | FAIL | FAIL | 0.36 | 0.55 | 0.55 | 0.51 | 0.52 | 6/10 |
| PM-pfcRL1 | FAIL | FAIL | 0.42 | FAIL | FAIL | 0.36 | 0.71 | 0.71 | 0.60 | 0.60 | 6/10 |
| PM-pfcRL2 | FAIL | 0.51 | 0.40 | 0.51 | 0.52 | 0.38 | 0.71 | 0.71 | 0.60 | 0.60 | 9/10 |

In particular, referring to Table 1, PM-pfcRL2 successfully solved nine tasks out of the ten tasks and scored the highest on eight out of nine tasks in terms of the normalized reward. Both GM-metaRL and PM-pfcRL1 showed the second-best performance. Although the performance of the PM-pfcRL1 was the same as that of the GM-metaRL, the PM-pfcRL1 outperformed in five out of six tasks. Taken together, these results suggest that the Prefrontal RL models (PM-pfcRL1 and PM-pfcRL2) have the best ability to generalize what they learn from the original task.

There may be provided a potential information-theoretic measure for quantifying generalizability of RL models. In order to better understand the nature of the ability to generalize, information-theoretic analysis was performed. This analysis was designed to quantify (1) the amount of information transferred from the observation of the past episodes of events to the RL model's action and (2) the degree of optimality in its action. A hypothesis was made in which the higher the generalizability, the more efficiently the RL model encodes episodic information to generate optimal action. As such, it is expected that the generalizability of the model can be quantified as (1) mutual information from the episodic events and the agent's action (“episodic encoding efficiency”) as well as (2) the mutual information of the agent's action and the optimal action (“choice optimality”). The optimal action was defined as the action taken by the ideal agent, assuming that it is fully informed on the task's parameter changes. Episodic encoding efficiency is defined as

$$I ( {a}_{t} ; {a}_{t}^{*} ) ,$$

where Fₜ₋₁ and at are episode variables at a trial t−1 and an action at a trial t, respectively. The choice is defined as

$$I ( {a}_{t} ; {a}_{t}^{*} ) ,$$

where aₜ and aₜ* are choices (actions) t, respectively. The choice optimality is defined as of the RL agent and an ideal agent, respectively. A hypothesis was made in which one fundamental requirement of a highly generalizable RL agent is the ability to transfer information from past episodes to its action and task performance. Accordingly, the correlation between episodic encoding efficiency and choice optimality called “episodic encoding efficacy” may be one potential information-theoretic indicator of the generalizability of the RL model.

In order to validate the episodic encoding efficacy according to various embodiments, thereafter, the ratio

$$I ( {F}_{t - 1} ; {a}_{t} ) / I ( {a}_{t} ; {a}_{t}^{*} )$$

and goodness-of-fit statistics a proxy for episodic encoding efficacy were computed using the measures. It was found that the prefrontal RL (both PM-pfcRL1 and PM-pfcRL2) exhibited the highest level of the episode encoding effect. In particular, the most generalizable model, PM-pfcRL2, showed a significant correlation between episodic encoding efficiency and choice optimality in 8 of our 10 tasks. Furthermore, it is to be noted that the empirical generalizability (FIG. 17) mostly matched R2 of the episodic encoding efficacy. These results have three important implications. First, the episodic encoding efficiency helps us better understand the nature of generalizability. Second, the episodic encoding efficacy can be a good candidate for quantifying the agent's generalizability. This measure may be directly used to design highly generalizable RL algorithms.

According to various embodiments, the quantification method and apparatus having policy reliability, information processing efficiency, and generalizability for a generalizable human mimic type RL algorithm design can be provided, which can algorithmize the generalizability of the humans' RL process into an RL algorithm without overfitting.

Various embodiments may be applied to all fields which may be used by predicting all behaviors of human intelligence because all the behaviors occur based on a high-dimensional cognition function. For example, various embodiments can assist the human to achieve excellent performance by constructing an efficiently corresponding system in assisting the human behavior using a model that mimics the humans' context-dependent RL process.

In the Internet of things (IoT) field, cognition functions used to control each device may be various because various devices need to be controlled. In this case, the versatility of the system according to various embodiments can assist the human regardless of a difference between types of cognitive statuses necessary to control devices, and can develop AI capable of predicting a behavior without overfitting although a new device is included in an already constructed IoT ecosystem.

Furthermore, generalizability into various problems is also directly related to task humans' performance intelligence. The technology according to various embodiments enables task performance ability profiling for a judge, a doctor, a financial expert, a military commander, etc. whose complicated decision-making is important. Furthermore, this technology may also be used as a base technology for a customized system for smart education.

The humans' RL simulation algorithm derived using the technology according to various embodiments may also be used as a tool to understand a key process of human decision-making. The existing AI does not understand such humans' decision-making process. However, in the robotics field, AI that better predicts and assists the humans' behavior can be developed through the development of AI that predicts the humans' behavior characteristic without any change. In the gaming field, a more intelligent AI engine capable of a natural interaction with the human can be developed.

Today an advertising suggestion technology recommends new advertising based on the past search logs of the human. However, such an advertising suggestion technology chiefly proposes advertising completely out of an interested range of a user because the technology lacks the understanding of an individual humans' behavior characteristic. If the technology according to various embodiments is used, advertising with the range of a user's behavior can be recommended through resonance between the human-AI.

As described above, the design of human-like AI that promotes a characteristic of human intelligence is a useful technology which may be applied to the entire AI industry in that it can predict the humans' behavior more similarly and in that it can obtain better results with less efforts because a characteristic lies in efficiency of learning and performance. In particular, the RL is important for all AI developments that require an intelligent decision including the human because it gives a great help in problem-solving and decision-making.

The development of AI has a great disadvantage in that it can be applied to the solving of a specific problem not the solving of various problems although significant computation and time resources are invested in order to solve the specific problem situation. In contrast, the present system can be applied to the solving of various problems because it enables the development of a generalizable algorithm.

The present disclosure may be applied to validate natural intelligent characteristics of AI that is being developed and already developed. An error of such overfitting must be removed from a model to predict a humans' cognitive process by mimicking human intelligence because the model easily falls in the error of overfitting.

A quantification method for designing a generalizable human mimic type RL model executed through a computer according to various embodiments may include a policy reliability quantification step of executing quantification for how much RL models derived through inverse RL incorporate context changes in the task into a policy in order to transplant the generalizability of a humans' RL process into the RL models.

According to various embodiments, the policy reliability quantification step may include the steps of approximating a mapping function between a task parameter of a task and a behavior profile of a human, approximating a mapping function between the task parameter and a behavior profile of an RL algorithm, and comparing the approximated two mapping functions.

According to various embodiments, the quantification method may further include a generalizability validation step of validating a generalization probability of a task sampled from a task space in which the complexity of an actual problem of the task and context changes are parameterized for precise validation of generalizability.

According to various embodiments, the quantification method may further include a problem-solving information processing efficiency quantification step of quantifying whether a change or movement process of information connected from an environment to a behavior properly incorporates the behavior principle of key human intelligence.

According to various embodiments, the problem-solving information processing efficiency quantification step may include performing quantification using the Markov chain in order to identify connectivity between adaptability through policy reliability quantification of the human mimic type RL model that changes a problem-solving policy according to context changes and generalizability validated for problem-solving.

According to various embodiments, the problem-solving information processing efficiency quantification step may include calculating information compression efficiency that the past episode generated in a problem-solving process is incorporated into the RL policy and goodness-of-fit statistics of the behavior derived from the RL policy using mutual information on the Markov chain connected to an episode-policy-behavior.

According to various embodiments, the goodness-of-fit statistics of the behavior may be an index indicative of an information transfer system that incorporates episode information into an RL policy decision for optimal problem-solving.

According to various embodiments, the RL model may be a computational model in which model-based control and model-free control reliably encoding policy information that the human learnt are combined.

According to various embodiments, the RL model may be constructed through a learning method of goal matching (GM), behavior cloning (BC) and policy matching (PM).

The quantification apparatus 1300 for designing a generalizable human mimic type RL model according to various embodiments may include the policy reliability quantification unit 1310 for executing quantification for how much RL models derived through inverse RL incorporate context changes in the task into a policy in order to transplant the generalizability of a humans' RL process into the RL models.

According to various embodiments, the policy reliability quantification unit 1310 may approximate a mapping function between a task parameter of a task and a behavior profile of a human, may approximate a mapping function between the task parameter and a behavior profile of an RL algorithm, and may compare the approximated two mapping functions.

According to various embodiments, the quantification apparatus 1300 may further include the generalizability validation unit 1320 for validating a generalization probability of a task sampled from a task space in which the complexity of an actual problem of the task and context changes are parameterized for precise validation of generalizability.

According to various embodiments, the quantification apparatus 1300 may further include the problem-solving information processing efficiency quantification unit 1330 for quantifying whether a change or movement process of information connected from an environment to a behavior properly incorporates the behavior principle of key human intelligence.

According to various embodiments, the problem-solving information processing efficiency quantification unit 1330 may perform quantification using the Markov chain in order to identify connectivity between adaptability through policy reliability quantification of the human mimic type RL model that changes a problem-solving policy according to context changes and generalizability validated for problem-solving.

According to various embodiments, the problem-solving information processing efficiency quantification unit 1330 may calculate information compression efficiency that the past episode generated in a problem-solving process is incorporated into the RL policy and goodness-of-fit statistics of the behavior derived from the RL policy using mutual information on the Markov chain connected to an episode-policy-behavior.

According to various embodiments, the goodness-of-fit statistics of the behavior may be an index indicative of an information transfer system that incorporates episode information into an RL policy decision for optimal problem-solving.

According to various embodiments, the RL model may be a computational model in which model-based control and model-free control reliably encoding policy information that the human learnt are combined.

Various embodiments of this document may be implemented as a computer program including one or more instructions stored in a storage medium readable by a computer device. For example, a processor (e.g., the processor 140) of the computer device may invoke at least one of the one or more instructions stored in the storage medium, and may execute the instruction. This enables the computer device to operate to perform at least one function based on the invoked at least one instruction. The one or more instructions may include a code generated by a compiler or a code executable by an interpreter. The storage medium readable by the computer device may be provided in the form of a non-transitory storage medium. In this case, the term “non-transitory” merely means that the storage medium is a tangible device and does not include a signal (e.g., electromagnetic wave). The term does not distinguish between a case where data is semi-permanently stored in the storage medium and a case where data is temporally stored in the storage medium.

The embodiments of this document and the terms used in the embodiments are not intended to limit the technology described in this document to a specific embodiment, but should be construed as including various changes, equivalents and/or alternatives of a corresponding embodiment. In the description of the drawings, similar reference numerals may be used in similar components. An expression of the singular number may include an expression of the plural number unless clearly defined otherwise in the context. In this document, an expression, such as “A or B”, “at least one of A and/or B”, “A, B or C” or “at least one of A, B and/or C”, may include all of possible combinations of listed items together. Expressions, such as “a first,” “a second,” “the first” and “the second”, may modify corresponding components regardless of their sequence or importance, and are used to only distinguish one component from the other component and do not limit corresponding components. When it is described that one (e.g., first) component is “(functionally or communicatively) connected to” or “coupled with” the other (e.g., second) component, the one component may be directly connected to the other component or may be connected to the other component through another component (e.g., third component).

The “module” used in this document includes a unit configured with hardware, software or firmware, and may be interchangeably used with a term, such as logic, a logical block, a part or a circuit. The module may be an integrated part, a minimum unit to perform one or more functions, or a part thereof. For example, the module may be configured with an application-specific integrated circuit (ASIC).

According to various embodiments, each (e.g., module or program) of the described components may include a single entity or a plurality of entities. According to various embodiments, one or more of the aforementioned components or operations may be omitted or one or more other components or operations may be added. Alternatively or additionally, a plurality of components (e.g., modules or programs) may be integrated into one component. In such a case, the integrated components may perform one or more functions of each of a plurality of components identically with or similar to that performed by a corresponding one of the plurality of components before the components are integrated. According to various embodiments, other components performed by a module, an operation or another program may be executed sequentially, in parallel, repeatedly or heuristically, or one or more of the operations may be executed in different order or may be omitted, or one or more other operations may be added.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned elements, such as the system, configuration, device, and circuit, are coupled or combined in a form different from that of the described method or replaced or substituted with other elements or equivalents.

Accordingly, other implementations, other embodiments, and the equivalents of the claims fall within the scope of the claims.

1. A behavior-analysis apparatus comprising:
a signal acquisition module configured to receive behavior-related signals of a subject, the behavior-related signals including at least one of: a choice sequence, a reward history, a task-response record, or observation-derived state information;
a state-transition feature extraction module configured to generate, from the behavior-related signals, a plurality of state-transition features representing changes in latent behavioral states of the subject;
a first-level behavior-model fitting module comprising a processor and a memory, the first-level behavior-model fitting module configured to learn a first behavioral model from the state-transition features, the learning comprising estimating at least one behavioral parameter or a behavioral profile of the subject based on the state-transition features;
a task-volatility estimation module configured to compute, from the state-transition features and the learned first behavioral model, an uncertainty metric comprising at least one of: a state-transition uncertainty value, a state-space complexity value, or a novelty metric;
a prediction-error estimation module configured to compute a prediction error based on a difference between an expected behavioral outcome and an observed behavioral outcome derived from the behavior-related signals;
a second-level behavior-model fitting module configured to learn a second behavioral model based on output of the first-level behavior-model fitting module and based further on the uncertainty metric; and
a model-selection module configured to compare a behavioral parameter of the second behavioral model with respective behavior-model profiles associated with a plurality of candidate models stored in the memory, and to output a selected candidate model corresponding to a closest matching behavior-model profile.

2. The apparatus of claim 1, wherein the state-transition features comprise at least one of: a transition probability, a transition uncertainty measure, a temporal derivative, or a sequence-complexity metric.

3. The apparatus of claim 1, wherein the first behavioral model or the second behavioral model comprises a linear model, a probabilistic model, or a reinforcement-learning-inspired behavioral model.

4. The apparatus of claim 1, wherein the uncertainty metric comprises a task-volatility measure computed from variability of the state-transition features.

5. The apparatus of claim 1, wherein the prediction error comprises a value-based prediction error associated with reward information included in the behavior-related signals.

6. The apparatus of claim 1, wherein the second-level behavior-model fitting module generates a behavioral parameter that reflects both the uncertainty metric and the prediction error.

7. The apparatus of claim 1, wherein the model-selection module computes a similarity metric between the behavioral parameter of the second behavioral model and the behavior-model profiles of the candidate models.

8. The apparatus of claim 1, wherein the model-selection module outputs the selected model to an external behavioral-control system or analysis system.

9. A method for behavior analysis performed by an apparatus comprising a signal acquisition module, a state-transition feature extraction module, a first-level behavior-model fitting module, a task-volatility estimation module, a prediction-error estimation module, and a model-selection module, the method comprising:
acquiring behavior-related signals of a subject including at least one of: a choice sequence, a reward history, a task-response record, or observation-derived state information;
extracting, from the behavior-related signals, state-transition features representing changes in latent behavioral states of the subject;
learning, by the first-level behavior-model fitting module, a first behavioral model from the state-transition features;
computing an uncertainty metric comprising at least one of: a state-transition uncertainty value, a state-space complexity value, or a novelty metric based on the state-transition features and the first behavioral model;
computing a prediction error based on a difference between an expected behavioral outcome and an observed behavioral outcome;
learning a second behavioral model based on output of the first behavioral model and further based on the uncertainty metric;
generating a behavioral parameter of the second behavioral model by integrating the uncertainty metric and the prediction error;
comparing the behavioral parameter with a plurality of stored behavior-model profiles associated with candidate models; and
selecting and outputting a model corresponding to a behavior-model profile that best matches the behavioral parameter.

10. The method of claim 9, wherein extracting the state-transition features comprises computing at least one of: a transition probability, a transition uncertainty value, or a sequence-complexity metric.

11. The method of claim 9, wherein learning the first behavioral model or learning the second behavioral model comprises applying a modeling routine selected from a linear modeling routine, a probabilistic modeling routine, or a reinforcement-learning-inspired modeling routine.

12. The method of claim 9, wherein computing the uncertainty metric comprises computing a task-volatility value derived from variability in the state-transition features.

13. The method of claim 9, wherein computing the prediction error comprises generating a value-based prediction error associated with reward-related information in the behavior-related signals.

14. The method of claim 9, wherein generating the behavioral parameter comprises applying a weighted or nonlinear combination of the uncertainty metric and the prediction error.

15. The method of claim 9, further comprising transmitting the selected model to an external analysis or behavioral-control device.
